(19) United States
(12) Patent Application Publication
(10) Pub. No.: US 2015/0302006 A1
(43) Pub. Date: Oct. 22, 2015

(54) ADVANCED SEARCH FOR MEDIA CONTENT

(71) Applicant: VERIZON PATENT AND LICENSING INC., Basking Ridge, NJ (US)

(72) Inventors: Shan K. SASIDHARAN, Chennai (IN); Vijayakumar RAJAGOPAL, Dharmapuri (IN); Sireesh Chandra MUTHARAJU, Chennai (IN); Sravan C. REDDY, Hyderabad (IN)

(73) Assignee: VERIZON PATENT AND LICENSING INC., Basking Ridge, NJ (US)

(21) Appl. No.: 14/256,746

(22) Filed: Apr. 18, 2014

(51) Int. Cl. G06F 17/30; H04L 29/08

(52) U.S. Cl. CPC G06F 17/3002; G06F 17/30023; H04L 67/1097

(57) ABSTRACT

Methods and systems for indexing and efficiently retrieving media content in a database use subtitle data of media content items, including subtitle text and timestamps, for indexing the items. A media server coupled to a communication network identifies keywords in the subtitle data, and stores the media content items in association with metadata including the keywords. When a search request for media content is received, a search for media content includes searching the metadata of the stored media content to identify media content items having subtitles matching the search request. In one example, keywords are translated into multiple languages to enable searching of the metadata in multiple languages. In another example, timestamp information included in the subtitle data is also included in the metadata so as to enable a search to return a time point within a media content item at which a keyword matches the search request.

### BACKGROUND

In recent years, the amount of media content available to users, including movies and other videos, music, podcasts, and other audio, and picture files has greatly increased. The media content made available to a user by a commercial content provider can include commercial and/or public content, such as movies, television shows, as well as web content (e.g., training videos, short films, or the like). The media content available to the user via systems of the commercial content provider can further include the user's own content, including personal videos, audio recordings, and photos. Because of the large amount of media content available to the user, and because non-text media content (including videos, audio files, and pictures) are generally not readily searchable, the user may have difficulty locating a particular item of media content or otherwise searching for relevant media content. Improved methods and systems for locating media content items are therefore needed, including methods and systems for efficiently locating media content items of high relevance to users.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional block diagram of a system of networks/devices that provide various media-related services to users and support methods for efficiently indexing and searching for media content.

FIG. 2 is a flow diagram describing the operation of the system of FIG. 1 in response to receiving a search request for media content generated by a user of a user device or mobile device.

FIG. 3 is a schematic diagram illustrating a search methodology used by a media search engine to identify media content matching a search term of a search request.

FIG. 4 is a flow diagram describing the search methodology performed by the media search engine in response to receiving a request for media content.

FIG. 5 is a flow diagram illustrating a method performed by an enterprise media server for indexing media content accessible through the server.

FIG. 6 is a simplified functional block diagram of a computer that may be configured as a host or server, for example, to function as the enterprise media server or content provider server in the system of FIG. 1.

FIG. 7 is a simplified functional block diagram of a computer configured to function as a user or mobile device, a media player, or other work station or terminal device.

### DETAILED DESCRIPTION

In the following detailed description, numerous specific details are set forth by way of examples in order to provide a thorough understanding of the relevant teachings. In other instances, well known methods, procedures, components, and/or circuitry have been described at a relatively high-level, without detail, in order to avoid unnecessarily obscuring aspects of the present teachings.

The various methods and systems disclosed herein relate to advanced techniques for indexing media content stored in databases, and for identifying and retrieving media content efficiently from the databases in response to a search. Media content stored in the database, including video, audio, and picture files, is processed in order to associate each media item with metadata tags identifying the content of the media item. The processing of each media item includes retrieving subtitle data associated with the media item, processing the subtitle data to identify keywords or phrases, processing the keywords or phrases to retrieve related keywords, and associating with the media item in the database metadata storing the identified keywords, identified phrases, and related keywords.

The processing of each media item can be performed when the media item is loaded into the database, on a periodic or scheduled basis, in response to a new keyword related to a metadata tag of the media item being identified, or the like. The processing can further include translating the subtitle data from one language into a different language, and processing the media item to associate the media item with metadata tags in the different language for identifying the content of the media item in the different language.

The media content can be retrieved from the database based on a multi-level search. Specifically, the media content can be retrieved for playback through a media player (e.g., a television, set-top box, digital media player, or the like) in communication with a router through which a mobile device communicates. A user of the mobile device speaks a search term to a media content search application executing on the mobile device. The search application converts the spoken search term to text, and communicates the search term via the router to an enterprise media server. In the enterprise media server, the search term gives rise to a multi-level search. As part of the multi-level search, the enterprise media server determines whether the search term matches any channel or category of real-time media content provided by the media server (first-level search). If a match is identified, the multi-level search returns the match (or matches). If no match is identified, or if the user indicates that no returned match is satisfactory, the enterprise media server determines whether the search term matches any title of media content stored in a media database of the media server (second-level search). If a small number of matches is identified (e.g., 1-10 matches), the multi-level search returns the matches. If no match is identified, if a large number of matches is identified (e.g., more than 50), or if the user indicates that no returned match is satisfactory, the enterprise media server proceeds to a third-level search. Specifically, the media server performs a search for the search term in the metadata for media content stored in the media database. The media server can further perform a search for the search term across the Internet.

In some examples, the third-level search is a predictive search that prioritizes search results based on user information (e.g., user location, search language, user's previous searches, user profile information, or the like). In some examples, the third-level search includes searching for the search term among subtitle data for the media content stored in the media database. In a third-level search, multiple sets of search results may be provided based on the search characteristics. For example, a first set of search results can include results of the third-level search for media content stored in the media database, a second set of search results can include results of the third-level search for media content across the Internet, and a third set of search results can include results of the third-level search across subtitle data. In the example, all sets of search results may be prioritized based on user predictive information so that the search results most likely to be of relevance to the user are presented ahead of other search results.

Reference now is made in detail to the examples illustrated in the accompanying drawings and discussed below.

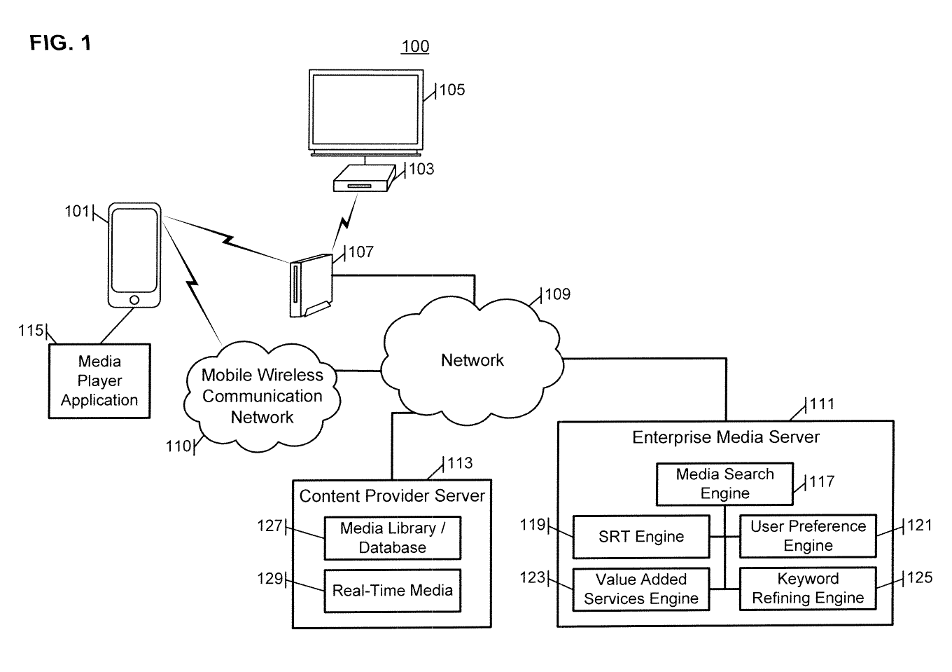

FIG. 1 illustrates a system 100 for providing a user with media content for viewing. The system 100 includes a media player 103, such as a set-top box, a digital media player or recorder, or the like, that is connected to a display screen 105, such as a television, projector, or the like, and is configured to output media for display to a user on the screen 105. The media player 103 is communicatively connected to a router 107, and via the router 107 and a network 109 to an enterprise media server 111 and/or a content provider server 113. The media player 103 receives media and other content from the enterprise media server 111 and/or the content provider server 113 via the router 107 and network 109 for display on the screen 105.

In one example, the router 107 is a Wi-Fi router or Ethernet router that communicates with the media player 103 through a wired and/or wireless communication connection, and the router 107 is connected through a wired connection (e.g., a digital subscriber line (DSL) connection, a cable-modem connection, a dedicated network line, or the like) to the network 109. The network 109 generally is a public network such as the Internet, although in some examples network 109 corresponds to an interconnection of one or more public and/or private networks. For example, the network 109 may include a private network of a provider of media services that operates and/or manages the enterprise media server 111 and the content provider server 113.

A user of the system 100 controls the media player 103 using a remote control or other appropriate means in order to cause the media player 103 to search, select, and retrieve media content from the enterprise media server 111 and/or the content provider server 113. The user can further use the remote control to manipulate the playback of media content through the media player 103, for example to pause, resume play, fast-forward, or rewind content.

The user of the system 100 can further control the media player 103 using a mobile device 101 such as a smartphone or tablet computer. In some examples, the mobile device 101 can be a computer, such as a laptop computer. Mobile device 101 and media player 103 may be referred to as user devices herein. Mobile device 101 executes a media player application 115 that is configured to interface with the enterprise media server 111. As part of the execution of the media player application 115, the media player application 115 generates and sends information to the enterprise media server 111 via a communication connection linking the mobile device 101 with the network 109. For example, when the mobile device 101 is communicatively connected to the router 107, the media player application 115 communicates with the enterprise media server 111 via the router 107 and network 109. When the mobile device 101 is communicatively connected to a mobile wireless communication network 110 (e.g., a 4G, LTE, or other mobile network), the media player application 115 communicates with the enterprise media server 111 via a base station of the mobile wireless communication network 110 communicatively connected to the network 109.

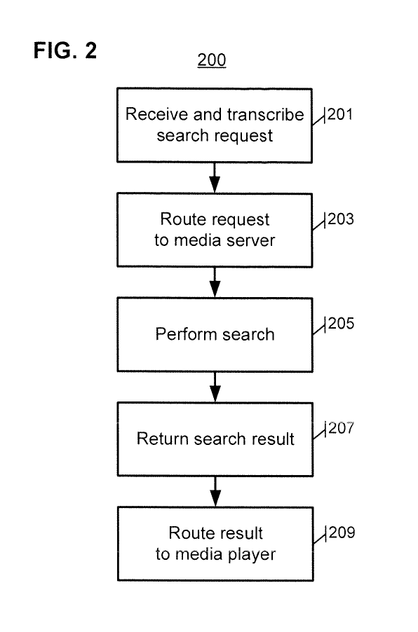

The media player application 115 executing on the mobile device 101 includes functionality for searching for, selecting, and retrieving media content from the enterprise media server 111 and/or the content provider server 113 for playback on the media player 103. Functionality of the media player application 115 will be described in more detail with reference to the flow diagram of FIG. 2.

The enterprise media server 111 is configured to provide media on demand services, including video on demand services. The content provider server 113 stores the media content available through or accessible through the enterprise media server 111 as a media database or library 127, or the like. The content provider server 113 can also route or otherwise provide access to real-time or live media content that is available through or accessible through the enterprise media server 111. While shown as separate and dedicated computers, the enterprise media server 111 and content provider server 113 can be implemented on a same computer appliance or as specialized application software running on one or more computer appliances. In general, one or both of the enterprise media server 111 and content provider server 113 are distributed across multiple server appliances designed to handle large volumes of queries and transmissions to/from large numbers of concurrent users, and queries to/from the servers 111 and 113 are handled by one or more load balancers.

The media content accessible through the enterprise media server 111 and stored on the content provider server 113 includes digital media files such as digital videos and movies, audio files and music, and picture files. The media content can include commercial/public media content as well as user's personal media content, such as personal videos, personal photos, or the like. One or both servers 111, 113 may be operated by a carrier of the mobile wireless communication network 110, or by third-party vendor independent of the mobile wireless carrier. Access to the media content may be restricted by one or both servers 111, 113 based on the identity of a user, for example to ensure that access to personal media content is restricted to only authorized users (e.g., only to the owner of the personal media content and other users authorized by the owner). Access to the media content may be restricted by one or both servers 111, 113 based on other criteria, such as based on a user's subscription to a media content service (e.g., access to movies may be restricted to only provide access to users with deluxe-level subscriptions), a user's payment for access to a media content item (e.g., access to a movie may be restricted until a user pays for the movie), a user-selected restriction on access to particular types of content (e.g., a user can restrict access to movies rated ‘R’), or the like.

In addition to providing on-demand media content, the enterprise media server 111 and content provider server 113 can provide access to broadcast or real-time media content 129, such as television content currently being broadcast over-the-air or on cable television. The real-time media content can include live media content, such as a live broadcast of a current event (e.g., a speech, news event, or the like).

FIG. 2 is a flow diagram 200 describing the operation of system 100 in response to a search request for media content generated by a user of the media player application 115. In the representative example of FIG. 2, the media player application 115 includes a voice-to-text function used for listening for a voice command from the user, transcribing the voice command into text, and generating a request for media services based on the transcribed command. In the example, the user speaks into a microphone of the mobile device 101 a media search command including a search term for media content. The media player application 115 receives the speech, recognizes the speech as a media search command, transcribes the speech into text, and generates a media search request including the transcribed search term (step 201).

The media search request is transmitted by the media player application 115 from the mobile device 101 to the enterprise media server 111. In general, the user of the mobile device 101 is located near the media player 103 and the router 107 when using the media player application 115, and the mobile device 101 is therefore communicatively connected to the router 107. The media search request is therefore routed across the communication connection from the mobile device 101 to the router 107, and forwarded by the router 107 to the enterprise media server 111 via the network 109 (step 203). Alternatively, if the mobile device 101 is not communicatively coupled to the router 107, the request is routed across a wireless connection from the mobile device 101 to a base station of the mobile wireless communication network 110 and on to the enterprise media server 111 via the network 109.

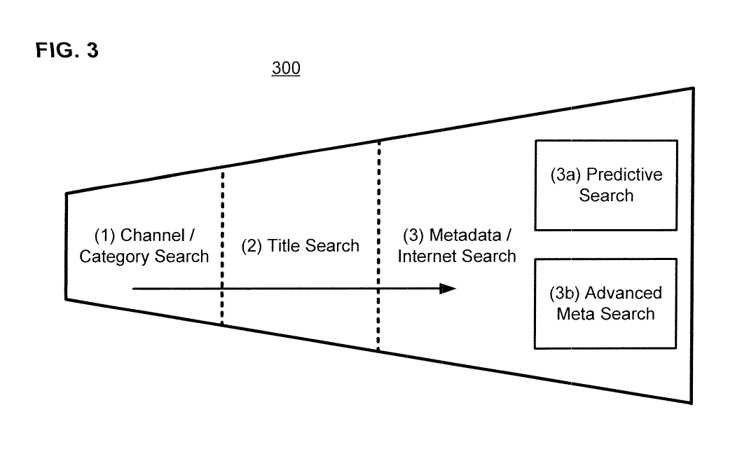

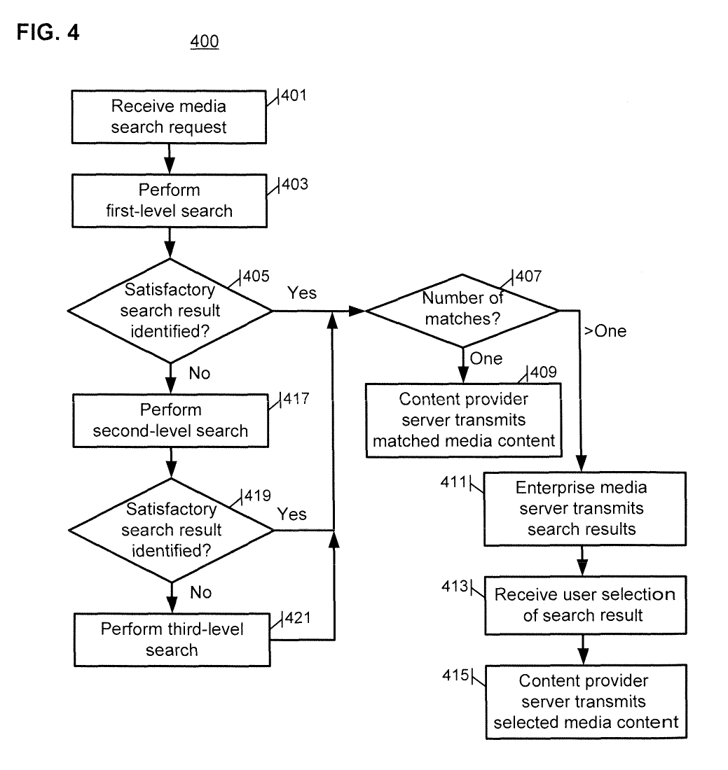

In response to receiving the media search request, the enterprise media server 111 performs a search for media content matching the search term included in the request (step 205). The search term can take the form of a single word or number, or a string of multiple words and/or numbers. Additional detail regarding the search is provided below in relation to FIGS. 3 and 4.

In response to performing the search, the enterprise media server 111 returns a search result identifying one or more media content items matching the search terms (step 207). In general, if a single media item is identified as a search result, the enterprise media server 111 causes the single media item to be returned. For example, the enterprise media server 111 causes the content provider server 113 to begin transmission of the single media item to the user. However, if multiple media items are identified in the search result, the enterprise media server 111 causes the search result identifying the multiple media items to be returned to the user.

In general, the search result is automatically routed to the media player 103 in step 209. Specifically, in situations in which the search request was routed via the router 107 in step 203, the enterprise media server 111 or content provider server 113 return the search result in step 207 to the router 107 through which the search request was received. In response to receiving the search result, the router 107 automatically forwards the search result to the media player 103 associated with the router 107 for presentation on the display screen 105. In some examples, the router 107 optionally forwards the search result to the mobile device 101 for presentation on a display screen of the mobile device 101. In situations in which the search request was routed via the mobile wireless communication network 110 in step 203, the enterprise media server 111 or content provider server 113 can return the search result to various destinations. The enterprise media server 111 or content provider server 113 can return the search result in step 207 to the router 107 if router 107 is associated in a memory of the enterprise media server 111 with the mobile device 101 from which the search request was received. Alternatively, the enterprise media server 111 or content provider server 113 can return the search result directly to the mobile device 101 from which the search request was received via the mobile wireless communication network 110.

In response to receiving the media search request, the enterprise media server 111 routes the request to the media search engine 117. The media search engine 117 is configured to perform a search for media content matching the search term included in the request. The media search engine 117 may rely on an SRT engine 119, a user preference engine 121, a value added services (VAS) engine 123, and a keyword refining engine 125 as part of its operation.

FIG. 3 is a schematic diagram 300 illustrating a search methodology used by the media search engine 117 to identify media content matching a search term of a search request. The diagram 300 shows an inverted search funnel showing three levels of search. Each search level is associated with a progressively wider/broader range of data selected from the data stored in the media database, and among which a search for data matching the search term is performed.

In a first level of search, the media search engine 117 accesses data on channels or categories of real-time media content accessible via the enterprise media server 111, and determines whether a match to the search request can be located using the first-level search. The data on channels includes channel numbers (e.g., “channel 144” or “144”) or channel names (e.g., “NBC news”) of television or other channels that can be accessed through the enterprise media server 111. The data on categories includes common categories of channels that are accessible through the enterprise media server 111, and can include such categories as “news” or “news channels,” “sports” or “sport channels,” or the like. In general, the enterprise media server 111 provides access to over-the-air and/or cable channel offerings, and the search is performed on data of channels accessible through such offerings. In some examples, the media search engine 117 searches through online channel data (e.g., YouTube channels), live streaming content (e.g., the President's State of the Union address), or other real-time media content available through the media server 111.

In a second level of search, the media search engine 117 accesses data on titles of media content provided by the media server 111, and determines whether a match can be located using the second-level search. In general, the second-level search is performed on titles of media content that are available for on-demand streaming through the media server 111. The data on titles includes title of movies (e.g., “Iron Man 3”), or television shows or television series (e.g., “NCIS”), or the like that are available for viewing through the enterprise media server 111. In one example, the data on titles includes titles of television shows and movies currently available on channels accessible through the enterprise media server 111, such as titles of television shows and movies currently being broadcast on a television channel. The titles of currently available television shows and movies can be retrieved from television guide data for a current time or for a time in the near future (e.g., in the next 15, 30, or 60 minutes).

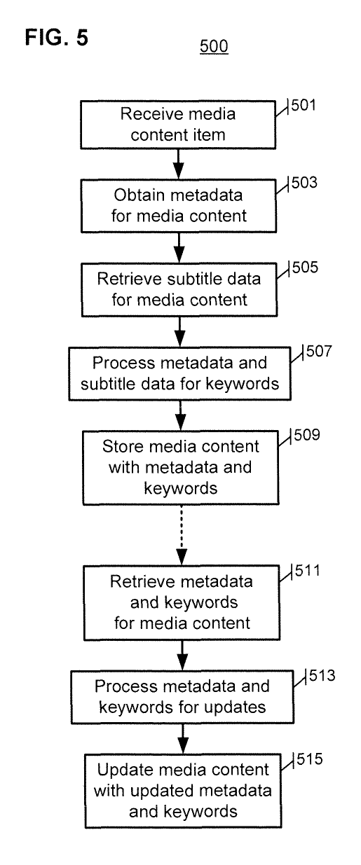

In a third level of search, the media search engine 117 accesses a broader range of data than that used in the first and second levels of search. In particular, the media search engine 117 accesses metadata associated with the channels and media content accessible through the media server 111. The metadata associated with channels and live media content includes data on content currently being broadcast on each channel and on content scheduled to be broadcast on each channel, including data on content title (e.g., name of television show), content cast (e.g., names of actors, directors, or the like), release date, synopsis, genre, reviews, and the like. The metadata associated with on-demand and other types of media content includes title, cast information, release date, synopsis, filename, and the like. In some examples, at least some of the metadata can be retrieved from an Internet library, such as from an Internet movie database (e.g., IMDB.com), based on title or other data stored by the media search engine 117. The metadata can include any information attached to the media content, such as information attached to the media content by content creators. The metadata can further include metadata described in more detail with reference to FIGS. 4 and 5 below.

In addition to searching through metadata stored in the media database, the media search engine 117 can in some embodiments additionally search through Internet content as part of a third level search. For example, the media search engine 117 may be connected via network 109 to the Internet, and may access and search through databases of Internet-accessible providers of streaming media content, such as YouTube, Hulu, Netflix, Amazon Instant Video, or the like. The media search engine 117 can further search through the Internet itself, and can restrict the Internet search to only return media content or to only return particular types of media content (e.g., videos, audio, podcasts), or to return both media content and other types of content (e.g., web pages, or the like).

The media search engine 117 has two additional functionalities. First, the media search engine 117 includes a predictive search functionality that enables the media search engine to select or prioritize search results that are determined to more likely correspond to content desired by the user. The predictive search functionality may be used as part of a third level search. The predictive search functionality may be performed, at least in part, by a user preference engine 121 communicatively coupled to the media search engine 117. The predictive search functionality can rely on user search data including data on previous searches performed by the user, and on previous search results selected by the user. For example, user search data identifying a prior search for soccer-related information may cause the search engine to prioritize search results pertaining to the soccer world cup in response to the search term “world cup.” The predictive search functionality can further rely on user profile data, including information on a user's gender, age, primary language, current or home location, or the like. For example, user profile data identifying a user home location in India may cause the search engine to prioritize search results pertaining to the cricket world cup in response to the search term “world cup.” The user profile data can additionally include user data stored by or accessible by the media search engine 117, such as contents of user communications (e.g., emails, social media posts, short message service (SMS) messages, or the like). The predictive search functionality can additionally rely on demographic or social data, such as the language of the search terms, to identify search results that are more likely to correspond to content desired by the user. For example, a search for “world cup” in Hindi may return search results for the cricket world cup, while a search for “world cup” in English may return search results for the soccer world cup. Additionally, the predictive search functionality can be based on factors including a current date and time, for example to prioritize search results relating to recently released movies and media content over other media content, and/or prioritize search results relating to content that is currently being broadcast or will be broadcast soon (e.g., in the next hour, or in the next day) over other broadcast content. The predictive search functionality can further be based on days-of-the-week on which and/or times-of-day at which a user typically uses the media player 103. Information on such days and times may be stored in a user profile accessible by the user preference engine 121. The predictive search functionality may further prioritize results based on the type of device from which a search request was received, for example to assign a higher priority to broadcast content in response to receiving a search request received from a television remote control, while assigning a higher priority to on-demand content in response to a search request received from a media player remote. The predictive search functionality may further prioritize results based on language, for example to assign a higher priority to search results having a primary language (e.g., a language of a media content item, or a language in which a media content item has been indexed) that matches a user's language (e.g., a language associated with a user profile, a language of a search request, or the like), while assigning a lower priority to content in languages different from the user's language.

In operation, in response to receiving a media search request, the media search engine 117 communicates the media search request to the user preference engine 121 that, in turn, performs a predictive search based on the search term of the request and the user search data, user profile data, demographic or social data, and/or the like. In particular, the user preference engine 121 begins by retrieving user search data, user profile data, demographic or social data, or the like, for use in performing the predictive search. In one example, the user preference engine 121 has access to user search data in the form of the previous search requests received by the user preference engine 121 and associated with the user. In the one example, the user preference engine 121 may not need to identify the user, or retrieve user profile data. Instead, the user preference engine 121 may retrieve from its memory stored information on recent search requests received from the same user device. In other examples, however, the user preference engine 121 identifies the user having submitted the search request based on one or more of an identifier of the user device (e.g., 101) from which the search request was received, an identifier for a user account or user profile currently in use on the user device from which the search request was received, an identifier for a router (e.g., 107) through which the search request was received, or the like. The user preference engine 121 may then retrieve data associated with the identified user from memory for use in the predictive search. In some examples, the user data accessed by the preference engine 121 is data associated with a single individual (e.g., in the case of user profile data associated with a user account), while in other examples the personal data corresponds to multiple persons residing in a household (e.g., in the case of user profile data associated with a router 107 or media player 103). The user data accessed by the preference engine 121 can also be more generally associated with large groups of users, notably in the case of location-based, demographic, or social data.

Additionally, the media search engine 117 includes an advanced meta search functionality that enables the media search engine 117 to search through subtitle data associated with media content accessible via the media search engine 117. The advanced meta search functionality may be performed, at least in part, by an SRT engine 119 and a keyword refining engine 125 communicatively coupled to the media search engine 117. The advanced meta search functionality enables the media search engine to retrieve SubRip text (SRT) files or other files that store subtitle data for an associated item of media content, and to search through the subtitle files to identify any subtitles matching the search terms. The advanced meta search functionality can search through the subtitle file as part of a third-level search to identify media content having subtitles matching the search term. More generally, however, the advanced meta search functionality indexes the subtitle file by searching through the subtitle file, by identifying keywords or phrases included in the subtitle file, and by including the identified keywords or phrases in the metadata of the media content item. The third-level search can then be performed more efficiently on the metadata only, since the metadata includes the keywords and phrases identified from the subtitle data.

The media search engine 117 may further communicate with a value added services engine 123 to provide certain services to users of the enterprise media server 111 and its media search functionality. The value added services engine 123 may monitor user permissions to ensure that the user has adequate access rights to use the media search functions and to access the search results and related media content. The value added services engine 123 may thus access user account information to determine the user's base permissions, and provide the user with opportunities to upgrade permissions or purchase additional rights to content and services in order to access the search functions, search results, and related content.

FIG. 4 is a flow diagram describing the search methodology 400 performed by media search engine 117 in response to receiving a request for media content. The diagram 400 illustratively describes in more detail the search methodology performed according to the inverted search funnel of FIG. 3.

The search method begins at step 401 with the receipt by the media search engine 117 of the media search request. The media search request is, for example, received from a user device 101 by the enterprise media server 111 in step 205 of method 200 and routed to the media search engine 117. In step 403, the media search engine 117 performs a first-level search using the search term included in the media search request. In response to performing the first-level search, the media search engine 117 either does not identify any channel or category matching the search term, or identifies one or more than one channel or category matching the search term.

In step 405, the media search engine 117 determines whether the search result, if any, of the first-level search is satisfactory. In general, if one or more matches are identified, the media search engine 117 determines that a satisfactory search result is obtained and proceeds to step 407. However, if no match is identified, the media search engine 117 determines that a satisfactory search result is not obtained and proceeds to step 417. In some situations, in response to a large number of matches being identified (e.g., more than 50 matches) in step 403, the media search engine 117 determines that a satisfactory search result is not obtained and proceeds directly to step 417.

At step 407, the media search engine 117 has determined that a satisfactory search result has been obtained. The media search engine 117 proceeds to determine the number of media content items matched in the search result. Upon determining that a single match is identified, the media search engine 117 and enterprise media server 111 cause the content provider server 113 to transmit the matched media content item to the user in step 409. Step 409 can include the enterprise media server 111 transmitting a notification to the content provider server 113 identifying the matched media content item and the user, router 107, or device 101 that the matched item should be transmitted to. Step 409 can further include the content provider server 113 beginning transmission of the matched media content item to the user, router 107, or device 101.

Upon determining that multiple matched media content items are identified, the media search engine 117 or the enterprise media server 111 transmit the search result identifying the multiple search results to the user, router 107, or device 101 in step 411. The multiple matched media content items are thus displayed to the user, and the user is provided with the opportunity to select one of the matched media content items through a user interface of the media player 103 or mobile device 101. If the user selects one of the matched media content items, the selection of the matched media content item of the search result is received by the enterprise media server 111 and/or by the content provider server 113 in step 413. In turn, in step 415, the content provider server 113 transmits the selected media content item to the user. Step 415, similarly to step 409, can include the content provider server 113 beginning transmission of the matched media content item to the user, router 107, or device 101.

If no match is identified in step 405, or if the user indicates in step 413 that none of the matched media content items are satisfactory, the media search engine 117 proceeds to step 417. In step 417, the media search engine 117 performs a second-level search using the search term included in the media search request. In response to performing the second-level search, the media search engine 117 either does not identify any title matching the search term, or identifies one or more than one title matching the search term.

In step 419, the media search engine 117 determines whether the search result of the second-level search is satisfactory. Step 419 is substantially similar to step 405 but relates to the search result of the second-level search. If step 419 results in the media search engine 117 determining that a satisfactory search result is obtained (e.g., if one or more matches are identified), operation proceeding to step 407. However, if no match is identified or if the user indicates in step 413 (performed following a second-level search taking place is step 417) that none of the matched media content item are satisfactory, the media search engine 117 proceeds to step 421.

In step 421, the media search engine 117 performs a third-level search using the search term included in the media search request. The third-level search of step 421 is exceedingly likely, due to the amount of metadata available and being accessed, to identify one or more items matching the search term. Thus, following step 421, operation proceeds to step 407 for further processing depending on the number of items identified as matching the search term.

In the processing of step 411, the media search engine 117 can operate in concert with the user preference engine 121 in order to select those matched items, among the multiple matched items, that are likely to correspond to content items desired the user's. The media search engine 117 can further operate in concert with the user preference engine. 121 in order to prioritize those matched items that are likely to correspond to content items desired by the user ahead of the other matched items among the search results presented to the user. In both situations, the media search engine 117 and user preference engine 121 rely on predictive searching techniques to prioritize or pre-select search results based on user information (e.g., user location, search language, user's previous searches, user profile information, or the like).

Additionally, the third-level search performed in step 421 can return a large number and variety of search results in response to searching through multiple different types of data. In situations in which a large number of search results are identified, the media search engine 117 can organize the search results in various categories for presentation to the user. For example, a first set of search results can include results of the third-level search for media content stored in the media database, a second set of search results can include results of the third-level search for media content across the Internet, and a third set of search results can include results of the third-level search across subtitle data. In the example, each set of search results may be prioritized based on user information, and each set of search results can be displayed separately to the user.

In some examples, the search methodology performed by the media search engine 117 can include variations on the flow diagram 400 shown in FIG. 4. In one embodiment, one or more levels of search may be skipped or passed over based on information received in the search request. In one example, in response to receiving the media search request in step 401, the media search engine 117 determines whether the request is received from or associated with a device that can receive or display broadcast content (e.g., television content received over the air, via cable, or the like). Upon determining that the device cannot receive or display broadcast content, the media search engine 117 may skip steps 403 and 405 and proceed directly to step 417 to perform a second-level search. The media search engine 117 can determine that the device from which the search request was received cannot receive or display broadcast content for example in a case in which the request is received from a mobile device 101 via the mobile wireless communication network 110. In contrast, when the media search engine 117 determines that the user can view broadcast content (e.g., in a case in which the request is received from a mobile device 101 via a router 107 having a media player 103 associated therewith), the media search engine 117 may proceed with a first-level search.

Alternatively or additionally, the media search engine 117 may determine whether the search request is received from a television remote control and, upon determining that the search request was received from the television remote, may limit the search to a first-level search (steps 403, 405, 407-415) without proceeding to the second-level or third-level searches. The media search engine 117 may further determine whether the search request is received from a media player or media player remote and, upon determining that the search request was received from the media player or media player remote, may limit the search to a first-level search or a second-level search (steps 403, 405, 407-415, 417) without proceeding to the third-level search.

In other example, in response to receiving the media search request in step 401, the media search engine 117 may skip the first-level search and/or second-level search based on other considerations. In one example, if the search term of the search request exceeds a pre-determined length (e.g., the search term includes 5 or more words), the media search engine 117 may determine that the search term does not correspond to a channel number, channel name, or category, and may automatically skip first-level search (steps 403 and 405) to proceed directly to a second-level search (in step 417). Similarly, if the search term of the search request exceeds a second pre-determined length (e.g., the search term includes 15 or more words), the media search engine 117 may determine that the search term does not correspond to a channel number, channel name, category, or media content title, and may automatically skip first-level and second-level searches (steps 403, 405, 417, and 419) to proceed directly to a third-level search (in step 421).

In another example, the determination to skip certain search levels may be based on the search term itself. If the search term includes (or begins with) the word “title,” for example, the media search engine 117 may proceed directly to a second-level search in step 417 without performing the first-level search (steps 403 and 405). Similarly, if the search term includes (or begins with) “SRT” or “subtitle,” the media search engine 117 may proceed directly to a third-level search in step 421 to identify matches of the remaining search terms in subtitle data. In such examples, the command words included in the search term (e.g., “title”, “SRT,” “subtitle”) are generally not included in the search for matches performed in steps 403, 417, or 421.

In order to increase the speed and efficiency of the media search functionalities described above, the media content accessible through the enterprise media server 111 can be indexed, classified, or catalogued. A method for indexing/classifying/cataloguing media content items is described in more detail with reference to FIG. 5 below.

FIG. 5 is a flow diagram illustrating a method 500 performed by enterprise media server 111 for indexing media content accessible through the server 111.

The method 500 begins in step 501 with the receipt or selection of a media content item. The media content item received in step 501 can be a media content item that is received for storage into a media library or database (shown, e.g., at 127), such as a new media content item uploaded to the database for storage. The media content item selected in step 501 can alternatively be a media content item that was previously stored in the media library or database 127. The previously stored content item may not have been previously indexed, and may be selected in step 501 for initial indexing. Alternatively, the content item may have been previously indexed, and may be selected in step 501 to verify or update the indexing. For example, previously stored content item can be selected on a periodic or pre-scheduled basis for verification and/or updating of indexing. The previously stored content item can be selected randomly. Alternatively, a particular previously stored content item can be selected for verification and/or updating of indexing, for example in response to determining that a new keyword that is associated with metadata of the media item has been identified and should be included in the metadata. In the example, upon identifying a new keyword that is synonymous with a metadata tag of the media item, the media item can be selected in step 501 so as to update the metadata of the media item with the new keyword.

In step 503, metadata that was previously associated with the media content item is retrieved. This metadata can include metadata that is stored as part of the media content item, or metadata that is stored in association with the media content item either in the media library or database or elsewhere. The metadata can be stored in a header or other information field of the media content item. The metadata can include a title, artist or source information, a brief description, and the like. The metadata can include information on keywords or categories associated with the media content.

In turn, in step 505, any subtitle data associated with the media content item is retrieved. The subtitle data may be stored as part of the media content item, but is more commonly stored as an SRT or other file separate from but associated with the media content item. The SRT file is a text file that includes the text of subtitles associated with the media content item, and a timestamp associated with each subtitle and indicating a time at which the subtitle should be displayed. The timestamp can indicate a time point as hours, minutes, seconds, and milliseconds following the beginning of the media file. The SRT file can be produced manually, for example by a person listening to and typing out the subtitle data, or automatically, for example using automated voice-recognition or other software to generate subtitle data and timestamps. In situations in which the selected media content item was previously stored in the database or library 127, the subtitle data can be retrieved from the database or library 127. In situations in which the selected media content item is being loaded into the database or library 127 for the first time, the subtitle data may be obtained from the same source as the media content item.

Once the metadata and subtitle data are obtained, processing proceeds to step 507 in which the metadata and subtitle data are processed. The processing can include the two following sub-steps. First, the subtitle data is processed by the SRT engine 119 and keyword refining engine 125 to identify any keywords located in the subtitle data. For each keyword identified in the subtitle data, an entry is created in the metadata of the media content item that identifies the keyword in association with a timestamp corresponding to the timestamp of the subtitle in which the keyword was identified. The keywords can be identified based on identifying matches in the subtitle data to keywords included in a master list of keywords maintained by the keyword refining engine 125. Keywords can be individual words or phrases including two or more words.

Second, the metadata (including the newly added metadata created based on the subtitle data) is processed by the keyword refining engine 125 to identify any equivalent words or keywords to include in the metadata. The equivalent words or keywords can include synonyms of words or keywords included in the metadata. The equivalent words or keywords include technical terms that refer to same or similar technologies identified in the metadata, including proprietary terms used to refer to similar technologies (e.g., different technologies that are developed by different companies or in different markets, but that are usually used similar purposes or have similar attributes). The equivalent technical terms can be retrieved from a corporate glossary or the like by the keyword refining engine 125. In one example, the corporate glossary may identify the terms LTE, long term evolution, 4G, WiMAX, HSPA+, evolved high-speed packet access, FMB, and fast mobile broadband as equivalent terms (even though such terms are not all synonyms). The corporate glossary may be continuously updated to include new equivalent terms as such terms appear in common usage. When equivalent words are identified, the keyword refining engine 125 amends the metadata of the media item to include the equivalent term in the metadata, such that the metadata includes both the original term and any identified equivalent term(s).

In step 509, the metadata is stored with the media content in the database 127. Specifically, the metadata is stored to include the keywords and timestamps identified by the SRT engine 119 in step 507, as well as to include the equivalent terms identified by the keyword refining engine 125 in step 507.

Following the storage of the media content item with the metadata and keywords in step 509, the indexing of the media content item in the enterprise media server 111 is complete. The media content item can thus be readily identified in the enterprise media server 111 in response to a search for media content. For example, the enterprise media server 111 may receive a search request and perform a search in accordance with the methods 200 and/or 400 described above. In response to receiving the search request, the enterprise media server 111 (and/or media search engine 117) searches for matches of a search term included in the request among the metadata and keywords stored for each media content item in step 509.

In some examples, the processing of step 507 additionally includes processing for associating with a media content item metadata and/or subtitle data in multiple languages, or for translating metadata and/or subtitle data. In such examples, the media content item received in step 501 may have metadata and/or subtitle data associated therewith that is in a language other than a default language associated with the enterprise media server 111. The received media content item may additionally or alternately include an indication of one or languages, other than a language of the media content item, according to which the media content item should be indexed. In either situation, the processing of step 507 can include the SRT engine 119 identifying any keywords located in the subtitle data and, for each keyword identified in the subtitle data, creating an entry in the metadata of the media content item that identifies the keyword in the subtitle language and/or in any additional languages (e.g., in a default language associated with the enterprise media server 111, and/or in any additional languages associated with the media item). The entry in the metadata is again associated with a timestamp corresponding to the timestamp of the subtitle in which the keyword was identified. For this purpose, the SRT engine 119 may have access to a translation dictionary identifying keywords and their translations or equivalent terms in multiple languages. In addition, the processing of step 507 can include the keyword refining engine 125 processing the metadata (including the newly added metadata created based on the subtitles) to identify any equivalent words or keywords to include in the metadata in each of the appropriate languages. The keyword refining engine 125 may have access to the translation dictionary for this purpose.

In general, the multi-language support described above enables a media content item that is in a foreign language (e.g., Hindi) to be catalogued using a default language (e.g., English) to enable the media content item to be readily identified as matching search terms in the default language. The multi-language support further enables a media content item in one language (e.g., English) to be readily identified as matching search terms in a foreign language (e.g., Hindi). In some situations, the processing of the media content item in step 507 can include translating the subtitle data into one or more additional languages, and storing the translation of the subtitle data into the additional language(s) with the media content item in the database 127. The translation can be stored in the same file as the original subtitle data, or in a file separate from the original subtitle data. However, the method described above enables a media content item in one language to be catalogued in additional language(s) without requiring the media content item (or the subtitle data of the media content item) to be translated. Indeed, only the metadata and keywords need be translated and stored in different languages according to the method described in the previous paragraph. In such examples, the metadata may include keywords stored in multiple different languages.

Following the storage of the media content item with the metadata and keywords in step 509, the indexing of the media content item in the enterprise media server 111 is complete. As shown in step 511-515, however, the enterprise media server 111 may be operative to reprocess media content items, for example to verify the accuracy of the indexing or to update the indexing (e.g., in order to index the media content item in one or more additional languages, or to add additional equivalent keywords to the indexing). Steps 511-515 may be performed on a periodic or pre-scheduled basis on media content items stored in a database, for example by randomly or sequentially selecting the media content items based on a date/time at which each media content item was last processed (e.g., processed in step 507). Steps 511-515 may be performed on a particular media content item stored in a database in response to a trigger for selecting the particular media content item. The trigger can include a new language being associated with the media content item, and/or a new keyword being identified that is equivalent to a keyword included in the metadata of the media content item.

In step 511, the metadata and keywords associated with the media content in the database are retrieved. In step 513, the media content item is processed substantially similarly to the processing described above in relation to step 507. In step 515, the metadata and keywords stored for the media content in the database are updated to include the results of the processing of step 513.

As described above in relation to step 507, the processing relating to a media content item includes associating with metadata of the media content item timestamps indicating a time point in the media content item related to the metadata. For example, a keyword that is identified from subtitle data of the media content item is stored in the metadata of the media content item with the timestamp of the subtitle in which the keyword was identified. The timestamp information is used to enable a user to begin playback of the media content item from the time point in the media content item identified by the timestamp.

More specifically, in response to a user performing a search for media content accessible through the enterprise media server 111 (e.g., a search in accordance with methods 200 and/or 400), the enterprise media server 111 may identify a media content item matching the search term included in the user's media search request. In particular, the enterprise media server 111 may identify a keyword that is stored in the metadata of the matching media content item and that matches the search term. In response to the identification, the enterprise media server 111 retrieves the timestamp associated with the keyword in the metadata. The enterprise media server 111 can then cause the content provider server 113 to transmit the matched media content to the user starting from the time point identified by the timestamp (e.g., in step 409 or 415 of method 400). In some examples, the content provider server 113 transmits the matched media content to the user starting from the time point identified by the timestamp, starting from a time that precedes the time point identified by the timestamp by a predetermined time interval (e.g., by starting playback from a time that is 10 seconds before the time point identified by the timestamp) or based on another time reference (e.g., by starting playback from a pre-stored time that precedes the time point identified by the timestamp, such as a pre-stored time indicative of the start of a chapter in the media content item), or the like.

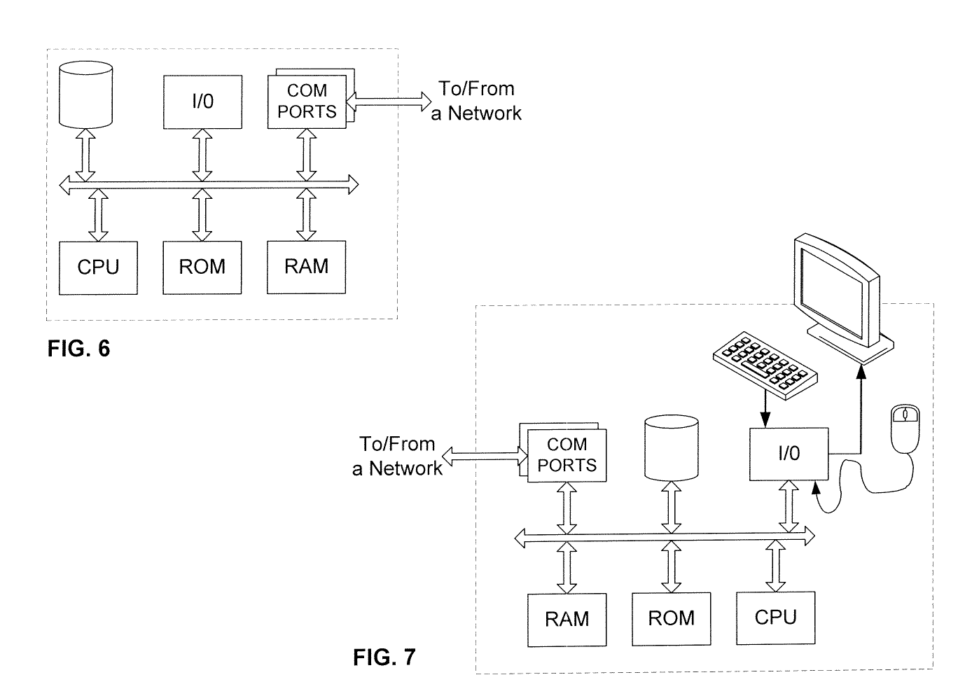

FIGS. 6 and 7 provide functional block diagram illustrations of general purpose computer hardware platforms. FIG. 6 illustrates a network or host computer platform, as may typically be used to implement a server such as enterprise media server 111 or content provider server 113. FIG. 7 depicts a computer with user interface elements, as may be used to implement a mobile device 101, media player 103, personal computer or other type of work station or terminal device, although the computer of FIG. 7 may also act as a server if appropriately programmed.

A server such as the server of FIG. 6, and/or a computer such as the computer of FIG. 7, includes a data communication interface for packet data communication. The server and/or computer also include a central processing unit (CPU), in the form of one or more processors, for executing program instructions. The server and/or computer platform typically include an internal communication bus, program storage and data storage for various data files to be processed and/or communicated by the server, although the server and/or computer often receives programming and data via network communications. Server functions may be implemented in a distributed fashion on a number of similar platforms, to distribute the processing load. The computer platform may include a user input/output interface including keys, display-screen, mouse, pointer, and/or touch-sensitive display.

Aspects of the methods for media content indexing and searching outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of a service provider into the computer platform of the mobile device, media player, enterprise media server, or content provider server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

A machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the mobile device, media player, enterprise media server, content provider server, etc. shown in the drawings. Volatile storage media include dynamic memory, such as main memory of such a computer platform. Tangible transmission media include coaxial cables, copper wire, and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method comprising:
retrieving subtitle data for a media content item, the subtitle data including a plurality of subtitles each having subtitle text and a timestamp, in a media server coupled to a communication network;
identifying one or more keywords included in the subtitle data;
storing the media content item in a database communicatively connected to the communication network, wherein the media content item is stored in the database in association with metadata for the media content item including the identified one or more keywords;
receiving in the media server a search request for media content stored in the database; and
performing a search of metadata for media content stored in the database to identify one or more media content items having metadata including a keyword matching a search term of the search request.

2. The method of claim 1, further comprising:
in response to identifying the one or more keywords, determining translations of the one or more keywords into a language other than a language of the subtitle data,
wherein the media content item is stored in the database in association with metadata for the media content item including the determined translations of the one or more keywords.

3. The method of claim 2, further comprising:
in response to performing the search, identifying a media content item stored in the database and having subtitle data that is in a language other than a language of the search term of the search request and that includes a subtitle text whose translation into the language of the search term of the search request matches the search term.

4. The method of claim 1, further comprising:
in response to identifying the one or more keywords included in the subtitle data, retrieving the timestamp of each subtitle including one of the one or more keywords; and
storing the media content item in the database in association with metadata for the media content item including the identified one or more keywords and, for each identified keyword, the retrieved timestamp of a subtitle including the keyword.

5. The method of claim 4, further comprising:
in response to performing the search, identifying a media content item stored in the database and having metadata including a keyword matching a search term of the search request; and
initiating transmission of the identified media content item from a time point determined based on the timestamp in the metadata that is associated with the keyword matched to the search term.

6. The method of claim 5, wherein the transmission of the identified media content item is initiated from a time point of the timestamp of a subtitle of the media content item including the keyword matched to the search term.

7. The method of claim 5, wherein the transmission of the identified media content item is initiated from a time point preceding the time point of the timestamp of a subtitle of the media content item including the keyword matched to the search term.

8. The method of claim 1, further comprising:
in response to identifying the one or more keywords included in the subtitle data, determining a technical term that refers to a same technology or a similar technology as one of the identified keywords,
wherein the media content item is stored in the database in association with metadata for the media content item including the identified one or more keywords and the determined technical term that refers to the same or similar technology as the one keyword.

9. The method of claim 1, wherein the performing the search of metadata comprises:
performing a first search of media content stored in the database to determine whether any media content item stored in the database has a title matching the search term of the search request; and
upon determining that no media content item stored in the database has a title matching the search term of the search request, performing a second search of metadata for media content stored in the database, wherein the second search is performed on a broader range of metadata stored in the database than the first search and determines whether any media content item stored in the database has any metadata matching the search term of the search request.

10. The method of claim 9, wherein the performing the search of metadata further comprises:
performing a search of media content stored in the database to determine whether any name, number, or category of a channel accessible through the media server matches the search term of the search request,
wherein the first search of media content is performed only upon determining that no name, number, or category of a channel accessible through the media server matches the search term of the search request.

11. The method of claim 9, wherein the performing of the second search includes determining whether any media content item stored in the database has associated subtitle data matching the search term of the search request.

12. A server comprising:
a central processing unit;
a data communication interface for packet data communication with user devices across a communication network; and
a memory storing machine readable instructions which, when executed by the central processing unit, cause the server to perform functions including functions to:
retrieve subtitle data for a media content item, the subtitle data including a plurality of subtitles each having subtitle text and a timestamp;
identify one or more keywords included in the subtitle data;
store the media content item in a database communicatively connected to the communication network, wherein the media content item is stored in the database in association with metadata for the media content item including the identified one or more keywords;
receive, via the data communication interface from a user device across the communication network, a search request for media content stored in the database; and
perform a search of metadata for media content stored in the database to identify one or more media content items having metadata including a keyword matching a search term of the search request.

13. The server of claim 12, wherein execution of the machine readable instructions by the central processing unit cause the server to perform further functions to:
in response to identifying the one or more keywords, determine translations of the one or more keywords into a language other than a language of the subtitle data,
wherein the media content item is stored in the database in association with metadata for the media content item including the determined translations of the one or more keywords.

14. The server of claim 13, wherein execution of the machine readable instructions by the central processing unit cause the server to perform further functions to:
in response to performing the search, identify a media content item stored in the database and having subtitle data that is in a language other than a language of a search term of the search request and that includes a subtitle text whose translation into the language of the search term of the search request matches the search term.

15. The server of claim 12, wherein execution of the machine readable instructions by the central processing unit cause the server to perform further functions to:
in response to identifying the one or more keywords included in the subtitle data, retrieve the timestamp of each subtitle including one of the one or more keywords; and
store the media content item in the database in association with metadata for the media content item including the identified one or more keywords and, for each identified keyword, the retrieved timestamp of a subtitle including the keyword.

16. The server of claim 12, wherein execution of the machine readable instructions by the central processing unit cause the server to perform further functions to:
in response to performing the search, identify a media content item stored in the database and having metadata including a keyword matching a search term of the search request; and
initiate transmission, to a user device across the communication network, of the identified media content item from a time point determined based on the timestamp in the metadata that is associated with the keyword matched to the search term.

17. The server of claim 16, wherein the transmission of the identified media content item is initiated from a time point of the timestamp of a subtitle of the media content item including the keyword matched to the search term.

18. The server of claim 16, wherein the transmission of the identified media content item is initiated from a time point preceding the time point of the timestamp of a subtitle of the media content item including the keyword matched to the search term.

19. The server of claim 12, wherein the function to perform the search of metadata comprises:
performing a first search of media content stored in the database to determine whether any media content item stored in the database has a title matching the search term of the search request; and
upon determining that no media content item stored in the database has a title matching the search term of the search request, performing a second search of metadata for media content stored in the database, wherein the second search is performed on a broader range of metadata stored in the database than the first search and determines whether any media content item stored in the database has associated subtitle data matching the search term of the search request.

20. The server of claim 19, wherein the performing the search of metadata further comprises:
performing a search of media content stored in the database to determine whether any name, number, or category of a channel accessible through the media server matches the search term of the search request,
wherein the first search of media content is performed only upon determining that no name, number, or category of a channel accessible through the media server matches the search term of the search request.
